(19) United States
(12) Patent Application Publication
(10) Pub. No.: US 2020/0047455 A1
(43) Pub. Date: Feb. 13, 2020

(54) FIBER PREFORM AND METHOD OF MAKING THE SAME

(71) Applicant: Coats Group PLC, Hayes (GB)

(72) Inventor: Probir Kumar Guha, Bloomfield Hills, MI (US)

(21) Appl. No.: 16/655,764

(22) Filed: Oct. 17, 2019

Related U.S. Application Data
(63) Continuation-in-part of application No. PCT/US2018/027968, filed on Apr. 17, 2017.
(60) Provisional application No. 62/486,166, filed on Apr. 17, 2017.

(51) Int. Cl. B32B 5/12; B32B 5/26; B32B 7/09; D05B 93/00

(52) U.S. Cl. CPC B32B 5/12; B32B 5/26; B32B 2262/02; D05B 93/00; B32B 7/09

(57) ABSTRACT

A fiber preform is provided for use in a resin transfer mold (RTM) process. By setting an approximate three-dimensional (3D) shape of fiber preform prior to insertion in an RTM mold, the resulting vehicle component quality and throughput are enhanced. The fusion of the stitching in the fiber preform is sufficient to retain the 3D shape of the preform needed for enhanced RTM molding.

### RELATED APPLICATIONS

This application is a continuation in part of PCT/US2018/027968 filed 17 Apr. 2018 that in turn claims priority benefit of U.S. Provisional Application Ser. No. 62/486,166 filed 17 Apr. 2017, the contents of which are hereby incorporated by reference.

### FIELD OF THE INVENTION

The present invention in general relates to fiber preforms for use in a resin transfer molding process, and more particularly to fiber preforms having a three-dimensional shape.

### BACKGROUND OF THE INVENTION

Tailored Fiber Placement (TFP) is a textile manufacturing technique in which fibrous material is arranged on another piece of base material and is fixed with an upper and lower stitching thread on the base material. The fiber material can be placed in curvilinear patterns of a multitude of shapes upon the base material. Layers of the fiber material may be built up to produce a two-dimensional fiber preform insert, which may be used as an insert for overmolding or a resin transfer process to create composite materials.

Resin transfer molding or overmolding (hereafter referred to synonymously as “RTM”) is a process in which the fiber preform is placed in a mold where a melt processible material is molded directly on and into the insert. Melt processible materials typically used in overmolding include elastomers and thermoplastics. The major overmolding processes include insert molding and two-shot molding. Materials are usually chosen specifically to bond together, using the heat from the injection of the second material to form a bond that avoids the use of adhesives or assembly of the completed part, and results in a robust composite material part with a high-quality finish.

Composite materials are increasingly used in industry because of their high strength to weight ratios. Unfortunately, due to the tendency of selective comingled fiber bundle positioning (SCFBP) fiber preforms to be limp in their two-dimensional form, voids or wrinkles are formed when the two-dimensional preform is placed in the typically three-dimensional resin transfer mold. Voids and wrinkles in transfer molded parts significantly reduce strength and modulus of the final composite material, making SCFBP fiber preform inserts unfavorable in terms of production cost, increased scrappage, and diminished throughput.

Thus, there exists a need for fiber preforms that avoid the problems associated with SCFBP based preforms for placement in a three-dimensional resin transfer mold.

### SUMMARY OF THE INVENTION

A fiber preform is provided for use in a resin transfer molding process. The fiber preform includes a substrate, a fiber bundle that includes a reinforcement fiber and optionally a thermoplastic fiber, where the thermoplastic fibers, when present, has a first melting temperature; and a thermoplastic thread having a second melting temperature that is lower than the first melting temperature of the thermoplastic fibers. The fiber bundle is arranged on the substrate and attached to the substrate by a plurality of stitches of the thermoplastic thread to form a first preform layer having a principal orientation, where the thermoplastic thread, when present, is melted to retain the fiber preform in a non-planar three-dimensional shape.

A method of forming a fiber preform is provided for use in a resin transfer molding process. The method includes: providing a substrate, applying a first layer of a fiber bundle to the substrate in a predetermined pattern having a principal orientation, where the fiber bundle includes a reinforcement fiber and optionally thermoplastic fibers, the thermoplastic fibers, when present, having a first melting temperature and reinforcing fibers; stitching the first layer of the fiber bundle to the substrate using a thermoplastic thread having a second melting temperature that is lower than the first melting temperature; building up subsequent layers of the fiber bundle from the first layer; and stitching each of the subsequent layers to a preceding layer using the thermoplastic thread.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic view of a fiber bundle stitched to a substrate forming a fiber preform according to one embodiment of the present invention;

FIG. 2 is a cross-sectional schematic view of the fiber bundle of FIG. 1;

FIG. 3 is an exploded perspective view a multi-layered fiber preform according to one embodiment of the present invention;

FIG. 4 is a perspective view of the multi-layered fiber preform of FIG. 3; and

FIG. 5 is a schematic view of the production of a three-dimensional fiber preform according to one embodiment of the present invention on a preliminary shaping mold.

### DETAILED DESCRIPTION OF THE INVENTION

The present invention has utility as a fiber preform for use in an RTM process. By setting an approximate three-dimensional (3D) shape of fiber preform prior to insertion in an RTM mold, the resulting vehicle component quality and throughput are enhanced. The fusion of the stitching in the SCFBP preform is sufficient to retain the 3D shape of the preform needed for enhanced RTM molding.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

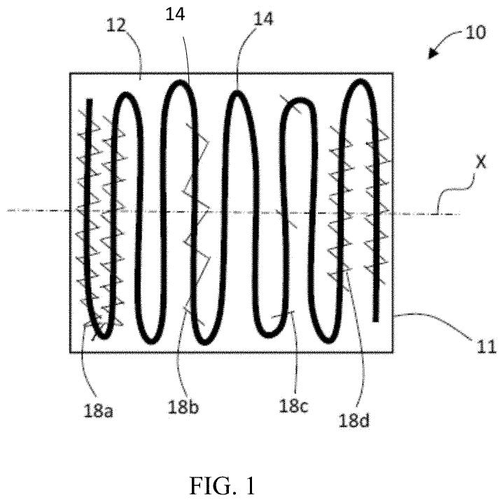

Referring now to FIG. 1, a fiber preform 10 according to one embodiment of the present invention is shown. The fiber preform 10 includes a substrate 12 which acts as a foundation or base upon with a fiber bundle 14 is applied. The substrate 12 may be a tear-off fabric or paper or other suitable material. The fiber bundle 14 is applied to the substrate 12 by a selective comingled fiber bundle positioning (SCFBP) method and attached to the substrate 12 by a plurality of stitch patterns of a thermoplastic thread 18 are shown as 18a, 18b, 18c, and 18d. The fiber bundle 14 may be applied in any arrangement on the substrate 12. The arrangement of the fiber bundle 14 on the substrate 12 may generally resemble the shape of the designed final composite material component, for example a structural component of an automobile. The fiber bundle 14 may be arranged in a principal direction, for example in a principal direction of stress of the final composite material component. In FIG. 1, the principal orientation of the fiber bundle 14 is along a longitudinal axis X of the fiber preform 10, however, other suitable orientations are also possible and may be used based on the design considerations and stresses for each composite material part. FIG. 1 illustrates only a first preform layer 11.

The fiber bundle 14 is made of comingled reinforcing fibers, such as those made of carbon, glass, aramid fibers, or any combination thereof and optionally thermoplastic fibers which serve to provide a matrix in a composite material made of both reinforcing and matrix fibers. The matrix fibers, being of a thermofusible nature may be formed from a thermoplastic material such as, for example, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The thermoplastic fibers are appreciated to be recycled, virgin, or a blend thereof. The thermofusible thermoplastic matrix fibers have a first melting temperature at which point the solid thermoplastic material melts to a liquid state. The reinforcing fibers may also be of a material that is thermofusible provided the thermofusion of the reinforcing fibers occurs at a temperature which is higher than the first melting temperature of the matrix fibers so that, when both fibers are used to create a composite, at the first melting temperature at which thermofusibility of the matrix fibers occurs, the state of the reinforcing fibers is unaffected.

As used herein, any reference to weight percent or by extension molecular weight of a polymer is based on weight average molecular weight.

As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix.

The thermoplastic fibers are appreciated to be recycled, virgin, or a blend thereof. The thermoplastic fibers in a comingled fiber bundle constitute from 20 to 80 weight percent of the comingled fibers in the present invention.

According to embodiments of the present invention, an inventive preform is suitable to use with any known composite component processing technique, such as RTM, LCM, thermoplastic overmolding, injection molding, and the like.

The reinforcement fibers in a comingled fiber bundle being glass fibers, polyaramid, carbon fibers, or a combination of any of the aforementioned. It is appreciated that the comingled fibers are either parallel to define a roving or include at least some fibers that are helically twisted to define a yarn. It is appreciated that the physical properties of reinforcing fibers retained in a helical configuration within a fixed matrix of a completed vehicle component are different than those of a linear configuration, especially along the reinforcing fiber axis. The relative number of reinforcing fibers relative to the thermoplastic fibers is highly variable in the present invention in view of the disparate diameters of glass fibers, polyaramid fibers, and carbon fibers. Thermoplastic fibers are also optional present.

According to embodiments of the present invention, the stitching thread is a thermoplastic thread, glass fiber thread, carbon fiber thread, aramid fiber thread, a metal wire, or a combination thereof. The thread diameter and thread material used for stitching are variables that are readily selected relative to the properties of comingled fiber bundle and the desired properties of the resulting preform and vehicle component.

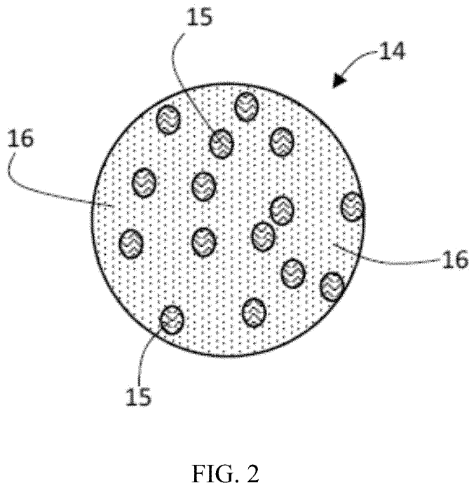

As shown in cross-section in FIG. 2, the fiber bundle 14 may include a subset of comingled fiber bundle fibers 15, a subset of roving fibers 16, or a combination thereof. The comingled fiber bundle fibers 15 are helical or spun, while the roving fibers 16 are parallel to one another and not helical. The fiber bundle 14 may be a single continuous fiber bundle fed from a spool in the SCFBP process to form the fiber preform 10. Alternatively, the fiber preform 10 may be formed of multiple separate fiber bundles. Using multiple fiber bundles to form the fiber preform allows for fiber bundles having different thermoplastic fibers and reinforcing fibers, which enables tuning of the fiber preform insert. Additionally, increasing the number of fiber bundles used in the SCFBP process speeds the fiber preform manufacturing process, which increases throughput and efficiency. The multiple fiber bundles may be applied to the substrate together starting from the same end of the substrate or the multiple fiber bundles may be applied spaced apart with each fiber bundle beginning at opposite ends of the substrate and converging at a middle region between the ends of the substrate.

According to embodiments of the present invention, the comingled fiber bundle includes entirely reinforcing fibers and not thermoplastic fiber. Alternatively, the comingled fiber bundle includes both reinforcing fibers and thermoplastic fibers. As described throughout the present disclosure, the reinforcing fibers include carbon fiber, glass fiber, aramid fibers, or a combination thereof.

The thermoplastic thread 18 that attaches the fiber bundle 14 to the substrate 12 may be a nylon or polyethylene material. The identity of the thermoplastic thread 18 is selected to have a melting temperature that is lower than the melting temperature of the thermoplastic fibers of the fiber bundle 14. At this lower second melting temperature, the solid thermoplastic thread 18 melts to a liquid state. At this lower melting temperature, thermofusibility of only the thermoplastic thread 18 occurs, while the state of the thermoplastic fibers of the fiber bundle 14 is unaffected. According to various embodiments of the present invention, the melting temperature differential between the melting temperature of the thermoplastic fiber of the fiber bundle 14 (first melting temperature) and the melting temperature of the thermoplastic thread 18 (second melting temperature) may be at least 50° C., while in other embodiments the melting temperature differential may be more than 100° C.

The fiber preform 10 is tunable and easily changed and adapted for varying design requirements. The properties and characteristics of the fiber preform may be changed and modified based on controlling parameters of the various components of the fiber preform including parameters of the fiber bundle 14, the thermoplastic thread 18, and the plurality of stitches and stich patterns of the thermoplastic thread 18. Parameters of the fiber bundle may include, but are not limited to, a diameter of the fiber bundle, a ratio of the thermoplastic fibers to the reinforcing fibers, a composition of the thermoplastic fibers, and a composition of the reinforcing fibers. Parameters of the thermoplastic thread may include, but are not limited to, a denier of the thermoplastic thread, a composition of the thermoplastic thread, and a melting temperature of the thermoplastic thread. The parameters of the plurality of stitches of the thermoplastic thread 18 may include, but are not limited to, a linear distance between the stitches and a tension of the stitches. The details of forming such a preform are detailed in a co-pending provisional application entitled “VEHICLE COMPONENT BASED ON SELECTIVE COMINGLED FIBER BUNDLE POSITIONING FORM” filed contemporaneously herewith.

Referring again to FIG. 1, the plurality of stitches 18a-18d are shown in various zig-zag stitch arrangements. For example, the stitches may be closely spaced stitches 18a and 18d or spaced apart by a greater linear distance such as stitches 18b and 18c. The stitches may be continuously connected along the fiber bundle 14 such as stitches 18a, or the stitches may be discrete and separate single stitches 18c or separate groups of stitches such as stitches 18b and 18d. The plurality of stitches of thermoplastic thread 18 may also attach the fiber bundle to itself. Increasing the number of stitches used to attach the fiber bundle to the substrate increases the thermoplastic thread to fiber bundle ratio, which is yet another tunable parameter of the fiber preform. The tension of the plurality of stitches may also be controlled. For example, low tension stitches results in a lose attachment of the fiber bundle to the substrate and more thermoplastic thread material in the fiber preform. Alternatively, high tension stitches result in a tight attachment between the fiber bundle and the substrate, an ability to put the fiber bundle in compression, and less thermoplastic thread material in the fiber preform. The thermoplastic thread to fiber bundle ratio may be controlled according to design configurations by balancing the number, arrangement of, linear distance between, and tension of the plurality of stitches.

The thermoplastic thread intersects itself at various points throughout the fiber preform 10. When the fiber preform 10 is heated to the melting temperature of the thermoplastic thread (second melting temperature), the thermoplastic thread fuses to itself at those intersections to form tacking points. Increasing the number of stitches used to attach the fiber bundle to the substrate increases the number of tacking points.

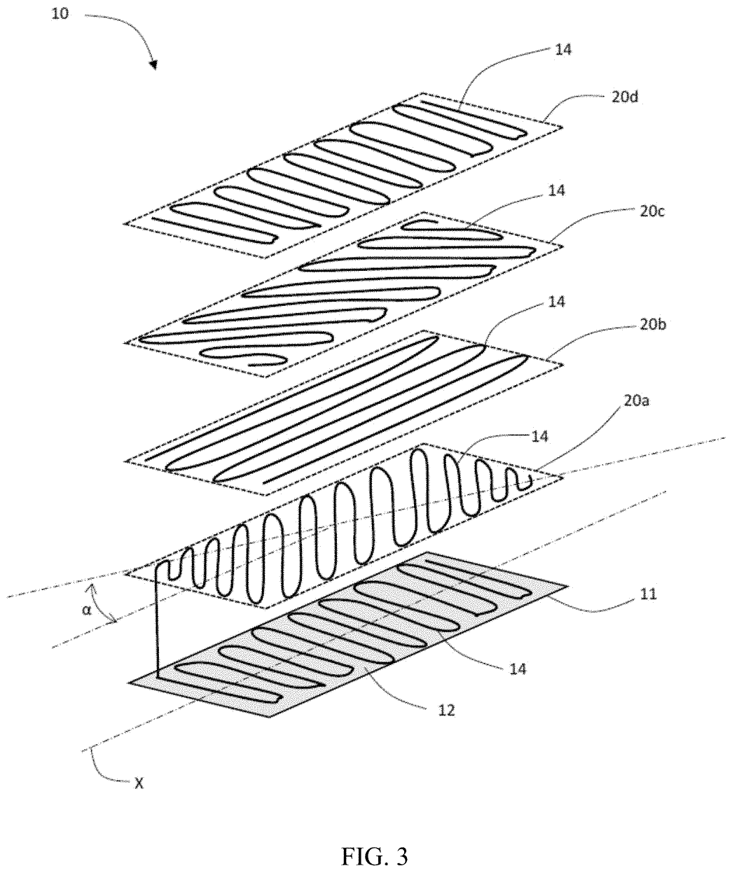

Referring now to FIG. 3, a multi-layered fiber preform 20 according to one embodiment of the present invention includes the first preform layer 11 with its principal orientation along the X axis and a plurality of subsequent preform layers 20a, 20b, 20c, 20d formed of the fiber bundle 14 successively stacked from the first preform layer 11. Each subsequent preform layer 20a, 20b, 20c, 20d is arranged on a preceding preform layer and attached to the preceding preform layer by additional stitches of the thermoplastic thread. For example, the first subsequent preform layer 20a is arranged on and attached to the preceding first preform layer 11, the second subsequent preform layer 20b is arranged on and attached to the preceding first subsequent preform layer 20a, the third subsequent preform layer 20c is arranged on and attached to the preceding second subsequent preform layer 20b, and the fourth subsequent preform layer 20d is arranged on and attached to the third subsequent preform layer 20c. While the example fiber preform 20 shown in FIG. 3 includes four subsequent preform layers for a total of five preform layers including the first preform layer, it is appreciated that the plurality of subsequent preform layers may include two to twenty layers. The fiber bundle 14 that forms each of the subsequent preform layers may be a continuation of the fiber bundle of the preceding preform layer or it could be a separate piece of fiber bundle.

In FIG. 3, the plurality of stitches of thermoplastic thread 18 are not shown for the sake of clarity, but it will be readily understood that each layer of fiber bundle 14 is attached to the preceding layer and/or to itself by a plurality of stitches identical to those explained throughout the present disclosure. It is appreciated that the stitches used to secure each subsequent preform layer could extend to the substrate, for example if it is desired to have a higher concentration of thermoplastic thread present in the fiber preform. Alternatively, the stitches used to attach each subsequent preform layer can extend to the preceding preform layer, which allows for a more efficient preform manufacturing process in that the penetration depth of the stitching needle need not be altered between the various layers of fiber bundle. After at least one of the subsequent preform layers has been stacked and attached to the first preform layer, the substrate may be removed from the fiber preform. Alternatively, the substrate may remain attached to the first preform layer until all of the subsequent preform layers have been stacked on and attached to the preceding preform layer, or the substrate can remain attached to the fiber preform throughout the composite material manufacturing process.

As shown in FIG. 3, the orientation of each subsequent preform layer may be offset from the orientation of the preceding preform layer. Offsetting the orientation of the various layers enables strength in multiple directions. The orientation of each subsequent preform layer may be offset from that of the preceding preform layer by an angular displacement a relative to the principal orientation of the first layer, for example the X axis. The layers can be overlaid with a variety of angular displacements relative to a first layer. If zero degrees is defined as the long axis X of the first preform layer 11, the subsequent preform layers are overlaid at angles of 0-90°. For example, in the fiber preform 20 shown in FIG. 3, the angular displacement a is 45° resulting in a 0-45-90-45-0 pattern of preform layers. Further specific patterns illustratively include 0-45-90-45-0, 0-45-60-60-45-0, 0-0-45-60-45-0-0, 0-15-30-45-60-45-30-15-0, and 0-90-45-45-60-60-45-45-90-0. While these exemplary patterns are for from 5 to 10 layers of uni-directional fibers, it is appreciated that the fiber preform may include from 3 to 20 layers. It is appreciated that the preform layers may be symmetrical about a central layer, in the case of an odd number of layers, or about a central latitudinal plane parallel to the players. That is, as shown in FIG. 3, the orientation of the first layer 11 and the last of the subsequent preform layers 20d are generally the same while the first subsequent layer 20a and third subsequent preform layer 20c are symmetrical with one another, such that the layers 11, 20a, 20c, and 20d are symmetrical about the center layer 20b. Providing the various preform layers with symmetrical orientations enables the fiber preform 10 to resist warping.

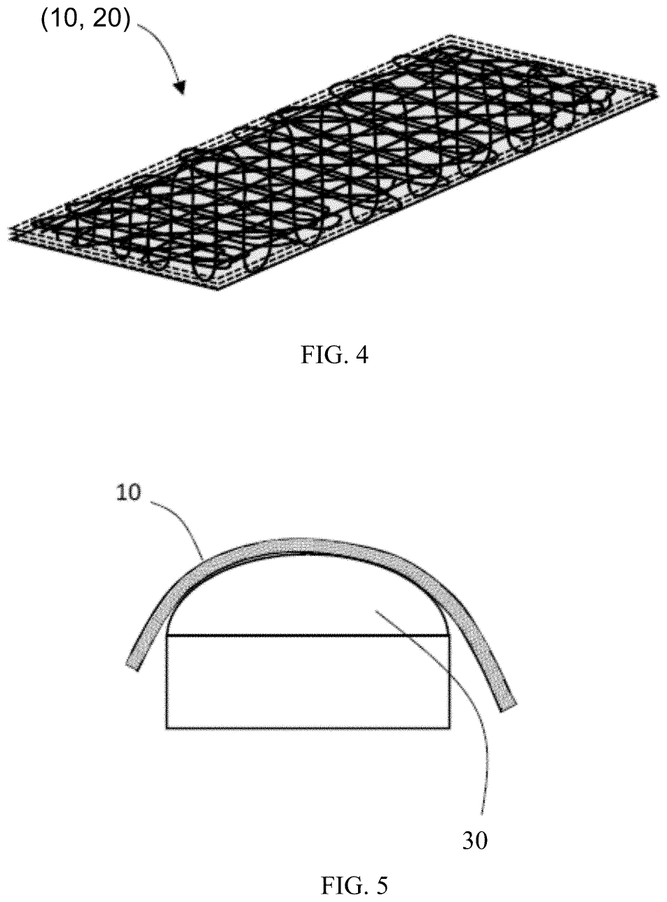

As shown in FIG. 4, the fiber preform 20 having of a plurality of preform layers has a generally two-dimensional shape, that is, while the various layers give the fiber preform 20 a thickness, the fiber preform is substantially flat or planar. Often, it is desired that the composite materials formed using a fiber preform of the present disclosure have a three-dimensional shape, for example a curve, an angle, or some other non-planar configuration. To manufacture three-dimensional composite material parts, a fiber preform is placed in a mold having a three-dimensional shape corresponding to the shape of the desired final composite material part. It has been found that typical fiber preforms formed using a selective comingled fiber bundle positioning process are difficult to place in such three-dimensional molds due in part to the floppy or limp nature of the two-dimensional fiber preform, which results in the fiber preform being improperly seated in the mold resulting in undesirable void between the insert and the mold surface or wrinkles in the inset. Such voids, wrinkles, and other undesirable alignment issues lead to concentrations of resin, weak points, and cracking in the final composite material parts.

The present invention provides a fiber preform capable of being pre-shaped into a three-dimensional design before being placed in the three-dimensional composite material mold. For example, according to various forms of the present invention, the fiber preform (10, 20) may be placed on a pre-shaping mold 30 such as that schematically shown in FIG. 5, however various other pre-shaping mold 30 shapes and configurations are appreciated. Gravity may assist with seating the fiber preform (10, 20) on the pre-shaping mold 30. Heat may be applied to one or both sides of the fiber preform (10, 20) by heat emanating from the pre-shaping mold 30 or from another source. When the fiber preform (10, 20) is heated to the second melting temperature, for example the temperature at which point thermofusion of the thermoplastic thread of the plurality of stitches takes place, the thermoplastic thread melts and fuses to itself where the thread intersects itself, and forms the tacking points throughout the fiber preform (10, 20) such that the fiber preform (10, 20) conforms to and maintains a three-dimensional shape corresponding to that of the pre-shaping mold 30. Because the fiber preform is heated to the second melting temperature which is lower than the melting temperature of the thermoplastic fibers of the fiber bundle 14, those thermoplastic fibers in the fiber bundle remain solid and unchanged.

The present disclosure also provides a method of forming a fiber preform such as the fiber preforms disclosed above. The method includes providing a substrate 12, applying a first layer 11 of a fiber bundle 14 of thermoplastic fibers having a first melting temperature and reinforcing fibers to the substrate 12 in a predetermined pattern having a principal orientation, for example along the X axis. The method continues by stitching the first layer 11 of the fiber bundle 14 to the substrate 12 using a thermoplastic thread 18 having a second melting temperature that is lower than the first melting temperature. Subsequent layers 20a, 20b, 20c, 20d of the fiber bundle 14 are then built-up from the first layer 11 and similarly stitched to a preceding layer using the thermoplastic thread 18. As described above, the fiber preform 10 produced according to the method of the present disclosure may have subsequent preform layers that are offset from the preceding layer by an angular displacement relative to the principal orientation of the first layer 11. The angular displacement may be anywhere from 0-90 degrees or, for example, may be any one of 15 degrees, 30 degrees, 45 degrees, 60 degrees, 75 degrees, and 90 degrees, or a combination of various angles. The method may also include removing the substrate 12 once the preform layers have been built-up form the first layer 11. The fiber preform may then be pre-shaped into a three-dimensional design before being placed in the three-dimensional composite material mold. For example, the fiber preform (10, 20) may be placed on a pre-shaping mold 30 such as that schematically shown in FIG. 5. Gravity may assist with seating the fiber preform (10, 20) on the pre-shaping mold 30. Upon heating the fiber preform (10, 20) to the second melting temperature, for example the temperature at which point thermofusion of the thermoplastic thread of the plurality of stitches takes place, the thermoplastic thread melts and fuses to itself where the thread intersects itself, and forms the tacking points throughout the fiber preform (10, 20) such that the fiber preform (10, 20) conforms to and maintains a three-dimensional shape corresponding to that of the pre-shaping mold 30. Because the fiber preform is heated to the second melting temperature which is lower than the melting temperature of the thermoplastic fibers of the fiber bundle 14, those thermoplastic fibers in the fiber bundle remain solid and unchanged. In addition to the substantially linear pattern of comingled fiber bundle positioning depicted in drawings with interspersed swithchbacks, it is appreciated that other patterns operative herein illustratively include spirals, and any space filling curve such as a Peano curve, dragon curve, or Sierpinksi curve.

The foregoing description is illustrative of particular embodiments of the invention, but is not meant to be a limitation upon the practice thereof. The following claims, including all equivalents thereof, are intended to define the scope of the invention.

1. A fiber preform for use in a resin transfer molding process, the fiber preform comprising:
a substrate;
a fiber bundle comprising reinforcing fibers and optionally thermoplastic fibers, the thermoplastic fibers having a first melting temperature; and
a thermoplastic thread having a second melting temperature that is lower than the first melting temperature of the thermoplastic fibers;
wherein the fiber bundle is arranged on the substrate and attached to the substrate by a plurality of stitches of the thermoplastic thread to form a first preform layer having a principal orientation, said thermoplastic thread melted to retain the fiber preform in a non-planar three-dimensional shape.

2. The fiber preform of claim 1 further comprising a plurality of subsequent preform layers formed of the fiber bundle and successively stacked from the first preform layer, each subsequent preform layer arranged on a preceding preform layer and attached to the preceding preform layer by additional stitches of the thermoplastic thread.

3. The fiber preform of claim 2 wherein an orientation of each subsequent preform layer is offset from that of the preceding preform layer by an angular displacement relative to the principal orientation of the first layer.

4. The fiber preform of claim 3 wherein the angular displacement between each of the preform layers is any one of 15 degrees, 30 degrees, 45 degrees, 60 degrees, 75 degrees, and 90 degrees.

5. The fiber preform of claim 1 wherein when the fiber preform is heated to the second melting temperature, only the thermoplastic thread melts to form tacking points throughout the fiber preform such that the fiber preform conforms to and maintains a three-dimensional shape.

6. The fiber preform of claim 1 wherein the substrate is removable from the fiber preform after the plurality of subsequent preform layers are stacked from the first preform layer and each of the subsequent preform layers is attached to the preceding preform layer.

7. The fiber preform of claim 1 wherein the fiber bundle is also attached to itself by the plurality of stitches of the thermoplastic thread.

8. The fiber preform of claim 1 wherein the fiber bundle includes a subset of yarn fibers, a subset of roving fibers, or a combination thereof.

9. The fiber preform of claim 1 wherein the fiber preform is formed of a single continuous fiber bundle.

10. The fiber preform of claim 1 wherein the fiber preform is formed of at least two separate fiber bundles.

11. The fiber preform of claim 1 wherein the fiber preform is tunable based on controlling parameters of the fiber bundle, the thermoplastic thread, the plurality of stitches, or a combination thereof.

12. The fiber preform of claim 11 wherein the controlling parameters of the fiber bundle comprise a diameter of the fiber bundle, a ratio of the thermoplastic fibers to the reinforcing fibers, a composition of the thermoplastic fibers, and a composition of the reinforcing fibers.

13. The fiber preform of claim 11 wherein the parameters of the thermoplastic thread comprise a denier of the thermoplastic thread, a composition of the thermoplastic thread, and a melting temperature of the thermoplastic thread.

14. The fiber preform of claim 11 wherein the parameters of the plurality of stitches comprise a linear distance between the stitches and a tension of the stitches.

15. A method of forming a fiber preform for use in a resin transfer molding process, the method comprising:
providing a substrate;
applying a first layer of a fiber bundle to the substrate in a predetermined pattern having a principal orientation, the fiber bundle comprising reinforcing fibers, and optionally thermoplastic fibers, wherein the thermoplastic fibers have a first melting temperature;
stitching the first layer of the fiber bundle to the substrate using a thermoplastic thread having a second melting temperature that is lower than the first melting temperature;
building up subsequent layers of the fiber bundle from the first layer; and
stitching each of the subsequent layers to a preceding layer using the thermoplastic thread.

16. The method of claim 15 wherein each of the subsequent layers of the fiber bundle is offset from the preceding layer by an angular displacement relative to the principal orientation of the first layer.

17. The method of claim 16 wherein the angular displacement is any one of 15 degrees, 30 degrees, 45 degrees, 60 degrees, 75 degrees, or 90 degrees.

18. The method of claim 15 further comprising removing the substrate from the fiber preform after each of the subsequent layers is stitched to the preceding layer using the thermoplastic thread.

19. The method of claim 15 further comprising placing the fiber preform on a mold having a shape and heating the fiber preform to the second melting temperature to melt only the thermoplastic thread thereby causing the fiber preform to retain the shape of the mold.
